(19) United States
(12) Patent Application Publication
(10) Pub. No.: US 2025/0366440 A1
(43) Pub. Date: Dec. 4, 2025

(54) COLLAPSIBLE PET CONTAINMENT SYSTEM WITH ADJUSTABLE PANELS AND ROLL EXTENDERS

(71) Applicant: Mitchell Strack, Virginia Beach, VA (US)

(72) Inventor: Mitchell Strack, Virginia Beach, VA (US)

(21) Appl. No.: 18/677,414

(22) Filed: May 29, 2024

(51) Int. Cl. A01K 1/03

(52) U.S. Cl. CPC A01K 1/033

(57) ABSTRACT

A collapsible pet containment system comprising a plurality of rigid frame panels connected by flexible mesh spanning between panel ends. Roll extender attachments with a roll of the mesh material removably connect between adjacent panels via connecting slots, allowing the enclosed area to be adjustable in size and shape. Anchoring mechanisms secure the panels to the ground. The lightweight, durable materials enable easy transport and setup. Additional features include height-adjustable panels, replaceable mesh, corner connectors, and accessory attachment points.

### Background

The present invention relates to the field of pet containment systems, particularly to collapsible, adjustable, and lightweight fences designed for outdoor use. The invention addresses the need for a versatile and user-friendly solution that allows pet owners to create safe and spacious play areas for their pets in various outdoor settings.

Traditionally, pet owners have relied on fixed fencing or expensive training methods to contain their pets in outdoor environments. However, these solutions often lack the flexibility and portability needed to accommodate different pet sizes, play areas, and outdoor activities. Moreover, fixed fencing can be costly and time-consuming to install, while training methods may not provide the physical barriers necessary to ensure pet safety.

Various attempts have been made to address these challenges. For example, the FXW Rollick Dog Playpen offers a collapsible and portable containment solution. However, this product has limitations in terms of weight, panel length, and versatility. Additionally, the Chinese patent CN101999320A discloses a novel pet fence with adjustable width and rotatable barriers. While this invention provides some improvements in terms of assembly and storage, it lacks the lightweight materials and adaptable design needed for optimal outdoor use.

The present invention, overcomes these limitations by combining lightweight and durable materials, such as mesh fabric paneling and flexible frame elements, with an innovative design that prioritizes adjustability, portability, and ease of use.

By offering these advantages, the present invention provides pet owners with a superior solution for creating safe and spacious play areas for their pets in outdoor environments. The invention's adaptability and user-friendly design make it an attractive alternative to traditional containment methods, enhancing the overall quality of life for both pets and their owners.

In summary, the present invention represents a significant advancement in the field of pet containment systems, addressing the need for a collapsible, adjustable, and lightweight solution optimized for outdoor use. By overcoming the limitations of existing products and methods, this invention provides pet owners with a versatile and effective tool for ensuring the safety and well-being of their pets in various outdoor settings.

### SUMMARY

In an aspect, a collapsible pet containment system is disclosed. The system may comprise a plurality of rigid frame panels, each panel having a first end and a second end, with a flexible mesh material spanning between the ends. At least one connecting slot may be disposed on each end of each rigid frame panel. The system may further include a plurality of roll extender attachments, each comprising a roll of the flexible mesh material, a first end configured to be removably inserted into the connecting slot of a first rigid frame panel, and a second end comprising an attachment piece configured to be removably inserted into the connecting slot of a second rigid frame panel. The plurality of rigid frame panels may be adjustably connected to form an enclosed area by the flexible mesh material spanning between adjacent panels and by connection of the roll extender attachments between the connecting slots of adjacent panels. A plurality of anchoring mechanisms may be configured to secure the rigid frame panels to a ground surface.

In another aspect, the flexible mesh material may be composed of a lightweight, weather-resistant nylon webbing, while each rigid frame panel may be composed of a durable, lightweight metal alloy. The connecting slots on each end of each rigid frame panel may comprise two slots, and the system may further include a plurality of end cap pieces configured to be removably inserted into unoccupied connecting slots.

The roll extender attachments may allow the flexible mesh material to be extended in multiple directions between adjacent rigid frame panels, enabling the enclosed area formed by the plurality of rigid frame panels to be adjustable in size and shape by varying the number and arrangement of panels and roll extender attachments used. The anchoring mechanisms may comprise stake elements configured to be driven into the ground surface, with each rigid frame panel comprising at least one anchoring point for securing the stake elements.

Additional features may include a carrying case for storing and transporting the system when collapsed, height-adjustable rigid frame panels to accommodate pets of different sizes, removable and replaceable flexible mesh material, and corner connectors to join the rigid frame panels at angles to form a polygonal enclosed area. The flexible mesh material may be available in various colors and patterns, and the rigid frame panels may include accessory attachment points for pet toys, water bowls, or other accessories.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates a perspective view of a single rigid frame pane of the collapsible pet containment system.

FIG. 2 provides an anterior view of the single rigid frame panel.

FIG. 3 depicts a lateral view of the rigid frame panel, with the connecting slot on the second end open and unoccupied.

FIG. 4 shows a lateral view of the rigid frame panel, with the connecting slot 108 on the second end covered by an end cap piece.

FIG. 5 presents an aerial view of the rigid frame panel, showcasing the top surface and four anchoring points which extend laterally from the bottom of the frame.

FIG. 6 illustrates a flow chart depicting a method of containing a pet using a collapsible containment system.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

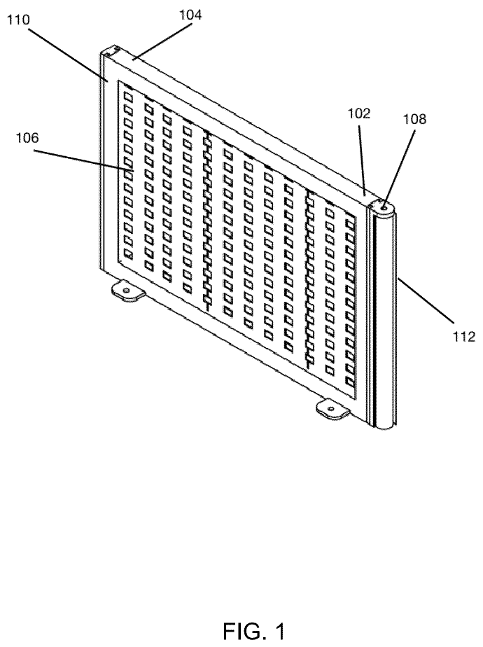

FIG. 1 illustrates a perspective view of a single rigid frame panel 100 of the collapsible pet containment system. The rigid frame panel 100 comprises a first end 102 and a second end 104, with a flexible mesh material 106 spanning between the first end 102 and the second end 104. The flexible mesh material 106 is composed of a lightweight, weather-resistant nylon webbing. The rigid frame panel 100 is composed of a durable, lightweight metal alloy or hard plastic. At least one connecting slot 108 is disposed on each of the first end 102 and the second end 104 of the rigid frame panel 100. In the embodiment shown, two connecting slots 108 are present on each end. An end cap piece 110 is removably inserted into one of the connecting slots 108, while a roll extender attachment 112 is removably inserted into the other connecting slot 108.

The roll extender attachment 112 comprises a roll of the flexible mesh material 114, a first end 116 configured to be removably inserted into the connecting slot 108 of the rigid frame panel 100, and a second end 118 comprising an attachment piece configured to be removably inserted into a connecting slot of an adjacent rigid frame panel (not shown).

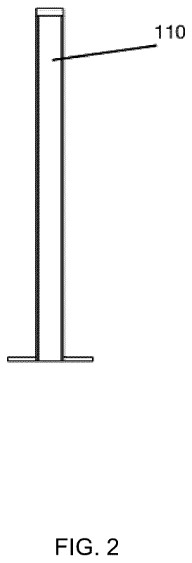

FIG. 2 provides an anterior view of the single rigid frame panel 100, clearly showing the end cap piece 110 inserted into one connecting slot 108 and the roll extender attachment 112 inserted into the other connecting slot 108. The flexible mesh material 106 spans the length of the rigid frame panel 100 between the first end 102 and the second end 104.

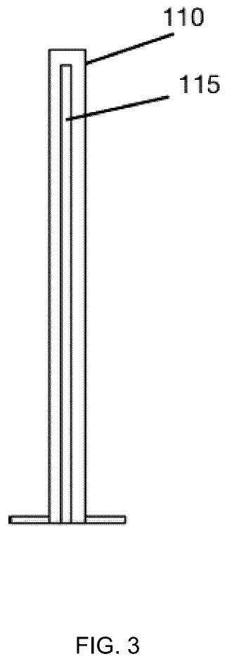

FIG. 3 depicts a lateral view of the rigid frame panel 100, with an end cap piece 110 inserted. In this embodiment the end cap piece features an attachment hook structure 115 for connecting with the end piece of the mesh that originates from the extender roll 112.

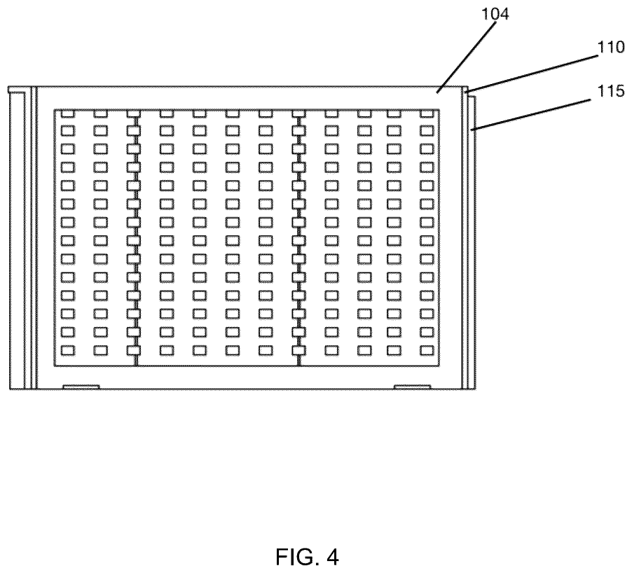

FIG. 4 shows a lateral view of the rigid frame panel 100, with the connecting slot 108 on the second end 104 covered by an end cap piece 110 with attachment hook structure 115. The end cap piece 110 is designed to fit securely into the connecting slot 108 when not in use, providing a finished appearance and preventing debris from entering the slot.

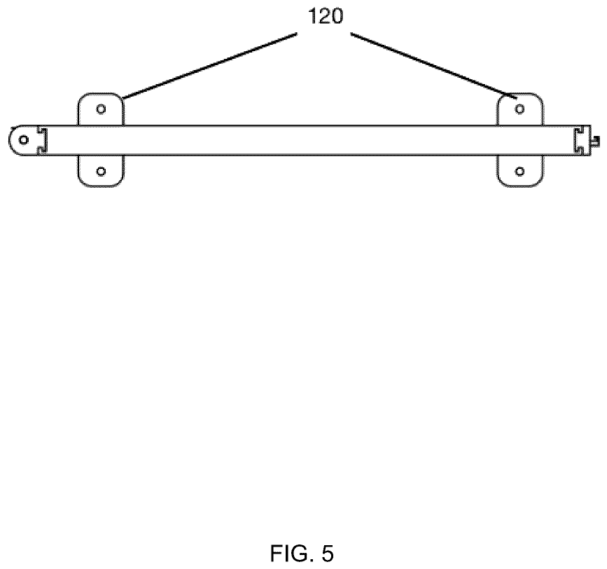

FIG. 5 presents an aerial view of the rigid frame panel 100, showcasing the top surface and four anchoring points 120 which extend laterally from the bottom of the frame. These anchoring points 120 are configured to secure stake elements (not shown) that can be driven into the ground surface to stabilize the rigid frame panel 100. The anchoring points 120 are positioned even across each side of the rigid frame panel 100 to provide optimal stability and support.

The collapsible pet containment system comprises a plurality of these rigid frame panels 100, which are configured to be adjustably connected to form an enclosed area by the flexible mesh material 106 spanning between adjacent panels and by connection of the roll extender attachments 112 between the connecting slots 108 of adjacent panels. The enclosed area formed by the plurality of rigid frame panels 100 is adjustable in size and shape by varying the number and arrangement of panels and roll extender attachments used. The system also includes a plurality of anchoring mechanisms, such as the stake elements (not shown), to secure the rigid frame panels 100 to the ground surface.

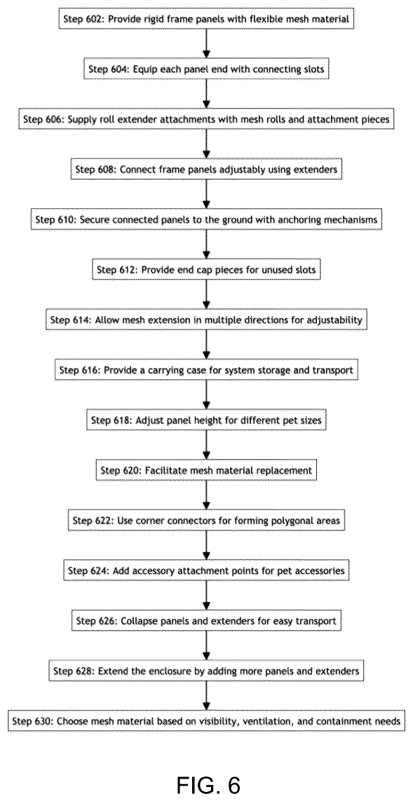

FIG. 6 illustrates a flow chart depicting a method of containing a pet using a collapsible containment system. The method begins by providing a plurality of rigid frame panels 100, each panel having a first end 102, a second end 104, and a flexible mesh material 106 spanning between the first end 102 and the second end 104 (step 602). At least one connecting slot 108 is disposed on each of the first end 102 and the second end 104 of each rigid frame panel 100 (step 604). The method further involves providing a plurality of roll extender attachments 112, each roll extender attachment 112 comprising a roll of the flexible mesh material 114, a first end 116 configured to be removably inserted into the at least one connecting slot 108 of a first rigid frame panel 100, and a second end 118 comprising an attachment piece configured to be removably inserted into the at least one connecting slot (108) of a second rigid frame panel 100 (step 606). The plurality of rigid frame panels 100 are then adjustably connected to form an enclosed area by spanning the flexible mesh material 106 between adjacent rigid frame panels 100 and connecting the roll extender attachment 112 to the end of an adjacent rigid frame panel 100 via an end cap piece 110 with an attachment hook structure. (step 608). The plurality of rigid frame panels 100 are secured to a ground surface using a plurality of anchoring mechanisms, such as stake elements (not shown) driven into the ground surface (step 610). Anchoring points 120 may be provided on each of the plurality of rigid frame panels 100 for securing the stake elements 122. The method may further include providing a plurality of end cap pieces 110, each end cap piece 110 configured to be removably inserted into an unoccupied connecting slot 108 of the rigid frame panels 100 (step 612). The roll extender attachments 112 can be configured to allow the flexible mesh material 114 to be extended in multiple directions between adjacent rigid frame panels 100, allowing for adjustability in the size and shape of the enclosed area formed by varying the number and arrangement of rigid frame panels 100 and roll extender attachments 112 used (step 614). Additional steps in the method may include:
providing a carrying case for storing and transporting the system components when collapsed (step 616);
adjusting the height of the rigid frame panels 100 to accommodate pets of different sizes (step 618);
removing and replacing the flexible mesh material 106 spanning between the panel ends (step 620);
using corner connectors to join panels at angles to form polygonal enclosed areas (step 622);
disposing accessory attachment points on the panels for pet toys, bowls, etc. (step 624);
collapsing the panels and roll extenders for storage and transport (step 626);
extending the enclosed area by connecting additional panels and roll extenders (step 628); and
selecting the mesh material from solid weave, perforated, or combination materials based on desired visibility, ventilation, and containment (step 630);

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A collapsible pet containment system comprising:
a plurality of rigid frame panels, each panel having a first end and a second end;
a flexible mesh material spanning between the first end and the second end of each rigid frame panel;
at least one connecting slot disposed on each of the first end and the second end of each rigid frame panel;
a plurality of roll extender attachments, each roll extender attachment comprising a roll of the flexible mesh material, a first end configured to be removably inserted into the at least one connecting slot of a first rigid frame panel, and a second end comprising an attachment piece configured to be removably inserted into the at least one connecting slot of a second rigid frame panel;
wherein the plurality of rigid frame panels are configured to be adjustably connected to form an enclosed area by the flexible mesh material spanning between adjacent rigid frame panels and by connection of the roll extender attachments between the at least one connecting slot of adjacent rigid frame panels; and
a plurality of anchoring mechanisms configured to secure the plurality of rigid frame panels to a ground surface.

2. The collapsible pet containment system of claim 1, wherein the flexible mesh material is composed of a lightweight, weather-resistant nylon webbing.

3. The collapsible pet containment system of claim 1, wherein each rigid frame panel is composed of a durable, lightweight metal alloy or hard plastic.

4. The collapsible pet containment system of claim 1, wherein the at least one connecting slot disposed on each of the first end and the second end of each rigid frame panel comprises two connecting slots.

5. The collapsible pet containment system of claim 4, further comprising a plurality of end cap pieces, each end cap piece configured to be removably inserted into an unoccupied connecting slot of the rigid frame panels.

6. The collapsible pet containment system of claim 1, wherein the plurality of roll extender attachments are configured to allow the flexible mesh material to be extended in multiple directions between adjacent rigid frame panels.

7. The collapsible pet containment system of claim 1, wherein the enclosed area formed by the plurality of rigid frame panels is adjustable in size and shape by varying the number and arrangement of rigid frame panels and roll extender attachments used.

8. The collapsible pet containment system of claim 1, wherein the plurality of anchoring mechanisms comprise stake elements configured to be driven into the ground surface.

9. The collapsible pet containment system of claim 8, wherein each of the plurality of rigid frame panels comprises at least one anchoring point for securing the stake elements.

10. The collapsible pet containment system of claim 1, further comprising a carrying case configured to store and transport the plurality of rigid frame panels, flexible mesh material, roll extender attachments, and anchoring mechanisms when the system is in a collapsed state.

11. The collapsible pet containment system of claim 1, wherein the plurality of rigid frame panels are configured to be adjustable in height to accommodate pets of different sizes.

12. The collapsible pet containment system of claim 1, wherein the flexible mesh material spanning between the first end and the second end of each rigid frame panel is removable and replaceable.

13. The collapsible pet containment system of claim 1, further comprising a plurality of corner connectors configured to join the plurality of rigid frame panels at angles to form a polygonal enclosed area.

14. The collapsible pet containment system of claim 1, further comprising a plurality of accessory attachment points disposed on the plurality of rigid frame panels, configured to accommodate pet toys, water bowls, or other pet-related accessories.

15. The collapsible pet containment system of claim 1, wherein the flexible mesh material is configured to provide visibility through the enclosed area.

16. The collapsible pet containment system of claim 1, wherein the plurality of rigid frame panels and the plurality of roll extender attachments are configured to be collapsible for storage and transport.

17. A method of containing a pet using a collapsible containment system, the method comprising:
providing a plurality of rigid frame panels, each panel having a first end, a second end, and a flexible mesh material spanning between the first end and the second end;
disposing at least one connecting slot on each of the first end and the second end of each rigid frame panel;
providing a plurality of roll extender attachments, each roll extender attachment comprising a roll of the flexible mesh material, a first end configured to be removably inserted into the at least one connecting slot of a first rigid frame panel, and a second end comprising an attachment piece configured to be removably inserted into the at least one connecting slot of a second rigid frame panel;
adjustably connecting the plurality of rigid frame panels to form an enclosed area by spanning the flexible mesh material between adjacent rigid frame panels and connecting the roll extender attachments between the at least one connecting slot of adjacent rigid frame panels; and
securing the plurality of rigid frame panels to a ground surface using a plurality of anchoring mechanisms.

18. The method of claim 17, wherein the flexible mesh material is composed of a lightweight, weather-resistant nylon webbing.

19. The method of claim 17, wherein each rigid frame panel is composed of a durable, lightweight metal alloy.

20. The method of claim 17, wherein disposing the at least one connecting slot on each of the first end and the second end of each rigid frame panel comprises disposing two connecting slots.

21-33. (canceled)
